(19) United States
(12) Patent Application Publication
(10) Pub. No.: US 2005/0162672 A1
(43) Pub. Date: Jul. 28, 2005

(54) Image forming apparatus

(76) Inventor: Akira Hiramatsu, Tokyo (JP)

Correspondence Address: FITZPATRICK CELLA HARPER & SCINTO, 30 ROCKEFELLER PLAZA, NEW YORK, NY, 10112, US

(21) Appl. No.: 10/500,290

(22) PCT Filed: Jan. 22, 2003
(86) PCT No.: PCT/JP03/00417

(30) Foreign Application Priority Data
Jan. 24, 2002 (JP) 2002-015689

(51) Int. Cl. G06K 1/00

(52) U.S. Cl. 358/1.9

(57) ABSTRACT

An image forming apparatus has image forming portions for forming images of different colors based on image information, a transferring portion for transferring images formed by the image forming portions sequentially in a superimposing manner, an image discriminator for automatically discriminating whether the image information is monochrome or multicolor, an image discriminating operation selector for selecting whether the image discriminator is to be operated, and a mode selector for selecting between a monochrome mode and a multicolor mode when the image discriminating operation selector is not selected. When the image discriminator is selected, the image forming speed in the monochrome and multicolor image formations is set to a first speed, irrespective of the result of the image discriminator. When the monochrome image forming mode is selected, the image forming speed in the monochrome image formation is set to a second speed higher than the first speed.

### TECHNICAL FIELD

The present invention relates to an image forming apparatus such as a copying machine, and particularly relates to a color image forming apparatus that can also form monochrome (or black and white) images.

### BACKGROUND ART

In conventional color image forming apparatus, in color mode, a color image is formed by transferring toner images of a plurality of colors including Y, M, C and Bk onto a recording paper sheet and fixing them thereon, while in monochrome mode, a monochrome (black and white) image is formed by transferring a toner image of Bk onto a recording paper sheet and fixing it thereon.

In the color image forming apparatus of the type in which a color image is formed by forming images of respective colors Y, M, C and Bk on a single image bearing member sequentially and then transferring them onto a recording paper sheet on a transferring drum sequentially, if the process speed under monochrome mode is the same as the process speed under color mode, the productivity of monochrome images is as low as four times the productivity of color images.

On the other hand, there is another type of known color image forming apparatus in which a plurality of image forming apparatus is provided side by side and image forming operations are sequentially performed with respective colors. In this type of image forming apparatus also, the process speed under monochrome mode is the same as the process speed under color mode, and so the image productivity under monochrome mode is the same as the image productivity under color mode.

In order to greatly enhance the productivity under monochrome mode relative to the productivity under color mode, it is necessary to increase the process speed under monochrome mode. For this purpose, it is necessary to change conditions for image forming processes such as exposure, development, transferring and fixing, and to increase the driving speeds of driving portions in order to meet the increase in the process speed. On the other hand, it is necessary to stabilize the rotating speeds of the respective driving portions prior to start of an image forming process. Therefore, if the driving speeds are increased, the time required from the startup of the motors of the respective driving portions up until the stabilization of their rotations is prolonged, so that the time required from start of a copying operation to start of an image forming process would be increased.

Especially, a polygon motor for rotating a polygon mirror used in an exposing system is required to have a very high accuracy in rotation in order to prevent uneven images from being formed. Therefore, if the rotating speed is changed, a long wait time is required until the rotation is stabilized.

Japanese Patent Application Laid-Open No. 10-177283 discloses an arrangement in which the process speed (i.e. image forming speed) at the time of a monochrome copying operation is set higher than the process speed at the time of a color copying operation. This conventional art document also discloses to discriminate whether an original is color or monochrome based on a pre-scanning operation so as to discriminate whether the image forming mode is set to a color mode or a monochrome mode, and to set the process speed in the monochrome mode high.

On the other hand, there is a known technology in which mixed originals including monochrome originals and color originals are successively copied with use of an original changing apparatus while automatically discriminating whether each original is a monochrome original or a color original to switch the image forming mode between a monochrome mode and a color mode automatically.

In connection with this, if the apparatus disclosed in Japanese Patent Application Laid-Open No. 10-177283 is used for image forming in conjunction with mixed originals (i.e. a mixture of monochrome originals and multi-color originals) while discriminating the color of each original, switching of the monochrome mode and the color mode would be successively performed during a continuous image forming operation, and so changing of the process speed should be frequently effected. Such changing of the process speed requires a wait time for stabilization of the rotation of driving means such as the above-mentioned polygon motor, every time the mode is switched, which may result in a significant reduction of productivity.

To cope with this problem, it may be conceived to provide two exposing systems corresponding to the respective process speeds and to switch the exposing systems. However, such a concept is not realistic, since it will increase costs greatly.

### DISCLOSURE OF INVENTION

The present invention has been made in view of the above-mentioned problems, and has an object to provide an image forming apparatus that has a high productivity even for a mixture of monochrome images and multi-color images.

An preferable mode of the invention that is intended to attain the above object is an image forming apparatus in which an image forming speed can be changed in accordance with an image forming mode, comprising:
a plurality of image forming means that are capable of forming images of different colors based on image information;
transferring means that is capable of transferring images formed by the plurality of image forming means sequentially in a superimposing manner;
image discriminating means for automatically discriminating whether the image information is monochrome or multi-color;
image discriminating operation selecting means for selecting whether or not the image discriminating means is to be operated; and
mode selecting means for selecting, when the image discriminating operation selecting means is not selected, between a monochrome image forming mode and a multi-color image forming mode,
wherein, when the image discriminating means is selected to be operated by the image discriminating operation selecting means, an image forming speed at the time of monochrome image forming and at the time of multi-color image forming is set to a first speed, irrespective of-the result of discrimination by the image discriminating means,
and wherein, when the monochrome image forming mode is selected by the mode selecting means, an image forming speed at the time of monochrome image forming is set to a second speed that is higher than the first speed.

These and other objects, features and advantages of the present invention will become more apparent upon consideration of the following description of the preferred embodiment of the present invention taken in conjunction with the accompanying drawings.

### BRIEF DESCRIPTION OF DRAWINGS

FIG. 1 is a cross sectional view showing principal portions of an image forming apparatus according to the present invention.

FIG. 2 is a schematic block diagram of the image forming apparatus according to the present invention.

FIG. 3, which is composed of FIGS. 3A and 3B, is a schematic flowchart showing an image forming process of the image forming apparatus according to the present invention.

### BEST MODE FOR CARRYING OUT THE INVENTION

### First Embodiment

In the following, an embodiment of the present invention will be described with reference to the drawings.

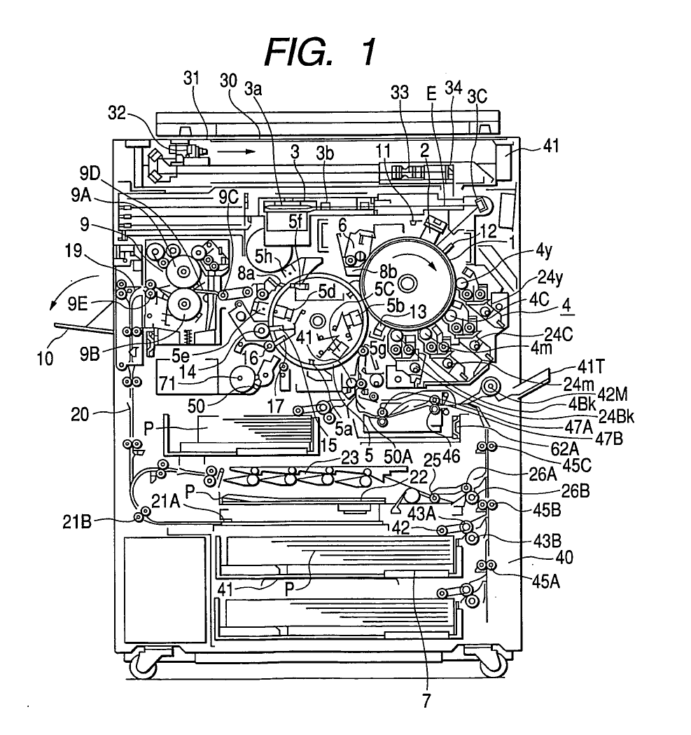

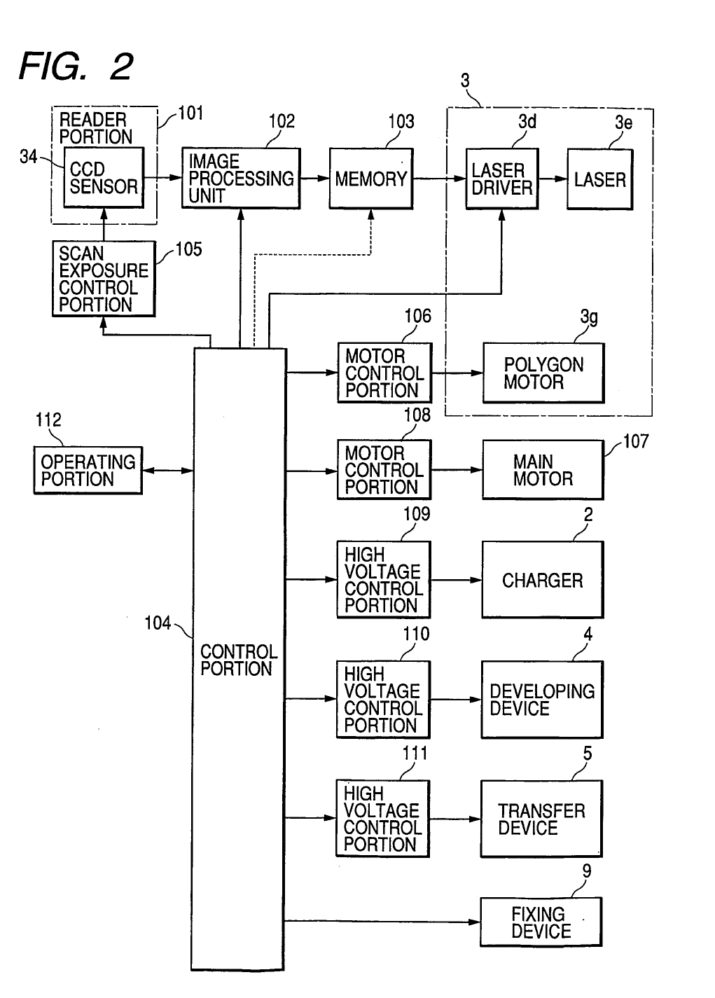

FIG. 1 is a schematic cross sectional view of a color image forming apparatus as an embodiment of the invention. The apparatus of this embodiment has a digital color image reader portion serving as image reading means provided in the upper part of the apparatus and a digital color image printer portion serving as an image forming apparatus provided in the lower part of the apparatus.

In the reader portion, an original 30 is placed on an original glass stand 31. The original 30 is then exposed to an exposure lamp 32 so as to be scanned, and a reflected light image from the original 30 is condensed by a lens 33 onto a CCD sensor 34, so that a color separation image signal is obtained. The color separation image signal is sent to an amplifying circuit (not shown), and then processed by an image processing unit (not shown). The processed signal is stored in a memory (not shown) for the moment.

In the printer portion, a photosensitive drum 1 serving as an image bearing member is supported in such a way as to be rotatable in the direction indicated by an arrow. Around the photosensitive drum 1, there is provided a pre-exposure lamp 11, a corona charger 2, a laser exposure optical system 3, an electro static voltmeter 12, four developing devices for different colors (serving as image forming means) 4y, 4c, 4m and 4Bk, light quantity detecting means 13 for detecting the light quantity on the drum, a transferring device (or transferring means) 5 and a cleaner 6.

In the laser exposure optical system 3, an image signal sent from the memory in the reader portion is converted by a laser output portion (not shown) into an optical signal. The converted optical signal in the form of a laser beam is reflected by a polygon mirror 3a and projected onto the surface of the photosensitive drum 1 after passing through a lens 3b and a mirror 3c.

During the image forming process in the printer portion, the photosensitive drum 1 is rotated in the direction indicated by the arrow, and the photosensitive drum 1, from which charge has been eliminated by the pre-exposure lamp 11, is charged uniformly by the charger 2. Then the photosensitive drum 1 is irradiated with an optical image E of each separate color, so that a latent image is formed.

Then, a prescribed developing device is activated to develop the latent image on the photosensitive drum 1, so that a toner image composed mainly of resin and pigment is formed on the photosensitive drum 1. The developing devices are adapted to be selectively brought to the vicinity of the photosensitive drum 1 by operations of eccentric cams 24y, 24c, 24m and 24Bk in accordance with the respective separated colors.

The toner image on the photosensitive drum 1 is transferred onto a recording material that has been fed from a recording material cassette 7 to a position opposed to the photosensitive drum 1 by a conveying system and a transferring device 5. The transferring device 5 of this embodiment includes a transferring drum 5a, a transferring charger 5b, an attracting roller 5g opposed to an attracting charger 5c for electrostatically attracting the recording material, an internal charger 5d and an external charger 5e. The transferring drum 5a is supported by a shaft so as to be rotationally driven. On a peripheral surface opening area of the transferring drum 5a, a recording material bearing sheet 5f made of a dielectric is integrally provided in a cylindrical shape in a tensioned state. The recording material bearing sheet 5f used in the machine of this embodiment is a dielectric sheet such as a polycarbonate film.

While the transferring device in the form of a drum (i.e. the transferring drum 5a) is rotated, the toner image on the photosensitive drum is transferred, by the aid of the transferring charger 5b, onto the recording material borne by the recording material bearing sheet 5f. Thus, images of a desired number of colors are transferred and superimposed sequentially on the recording material, which is electrostatically attracted to the recording material bearing sheet 5f and conveyed thereon, so that a full color image is formed.

In the case of forming a full color image, after the transfer of the toner images of four colors is completed, the recording material is stripped from the transferring drum 5a by the aid of a stripping claw 8a, a stripping upthrust runner 8b and a stripping charger 5h, and then delivered to a delivery tray 10 via a heat roller fixing device 9.

On the other hand, after the transfer, the photosensitive drum 1 is cleaned from residual toner on its surface by the cleaner, and then used for the image forming process again.

In order to prevent scattering and attachment of powder such as toner to the recording material bearing sheet 5f of the transferring drum 5a or attachment of oil to the recording material, cleaning is performed by a fur brush 14 and a backup brush 15 that is opposed to the fur brush 14 with the recording material bearing sheet 5f interposed therebetween. Such cleaning is performed before or after the image forming operation, or at any time when a jam (paper jam) occurs.

In this embodiment, the gap between the recording material bearing sheet 5f and the photosensitive drum 1 can be adjusted as desired by operating an eccentric cam 71 at a desired timing to move a cam follower 50 that is provided integrally with the transferring drum 5a. For example, during a stand-by period or while the power is turned off, the transferring drum and the photosensitive drum is spaced apart from each other.

FIG. 2 is a schematic block diagram of the image forming apparatus shown in FIG. 1.

The read image signal from the CCD sensor 34 of the reader portion 101 is sent to the image processing unit 102 so as to be subjected to image processing such as shading compensation, gray level correction and color correction, and then sent to the memory 103. The content of the memory is read out in synchronization with a video clock and sent to the laser exposure optical system 3. In connection with this, two types of video clocks are set in conformity with a fast monochrome speed-priority mode and a color mode/normal monochrome mode, which will be described later respectively.

The laser exposure optical system 3 includes a laser driver 3d to which an image signal from the memory 103 is sent, a laser (serving as a light source) 3e that emits light in accordance with a modulated signal sent from the laser driver 3d, a polygon mirror (serving as a reflecting member) 3a that reflects the light from the laser 3e to sequentially scan the surface of the photosensitive drum 1, and a polygon motor (serving as driving means) 3g for driving the polygon mirror 3a. In the fast monochrome speed-priority mode, the laser driver 3d is controlled in such a way as to increase the emitted light intensity of the laser 3e so that the same exposure amount on the drum surface would be assured.

A control portion 104 is connected with the above-mentioned CCD sensor 34 of the reader portion 101, a scan exposure control portion 105 that controls the scanning speed of a reading optical system of the reader portion in accordance with switching of process speeds, a motor control portion 106 that controls the rotation of the polygon motor 3g in accordance with the switching of process speeds, a motor control portion 108 that controls the rotating speed of a main motor 107 serving as a main drive source of the printer portion in accordance with the switching of process speeds, a high voltage control portion 109 that controls a high voltage output of the charger 2 in accordance with the switching of process speeds, a high voltage control portion 110 that controls a high voltage output of the developing device 4 in accordance with the switching of process speeds, a high voltage control portion 111 that controls a high voltage output of the transferring device 5 in accordance with the switching of process speeds, and the fixing device 9 in which an controlled temperature for fixing can be controlled in accordance with the switching of process speeds. An operating portion 112 is also connected to the control portion 104 for allowing entry of various settings, such as a mode switching, of the image forming apparatus. In the fast monochrome speed-priority mode, the control portion 104 controls respective high voltage control sections in such a way that their high voltage outputs are increased, in order to keep their charging abilities per unit area constant, and also raises the controlled temperature for fixing in accordance with an increase in the number of sheets fed per unit time.

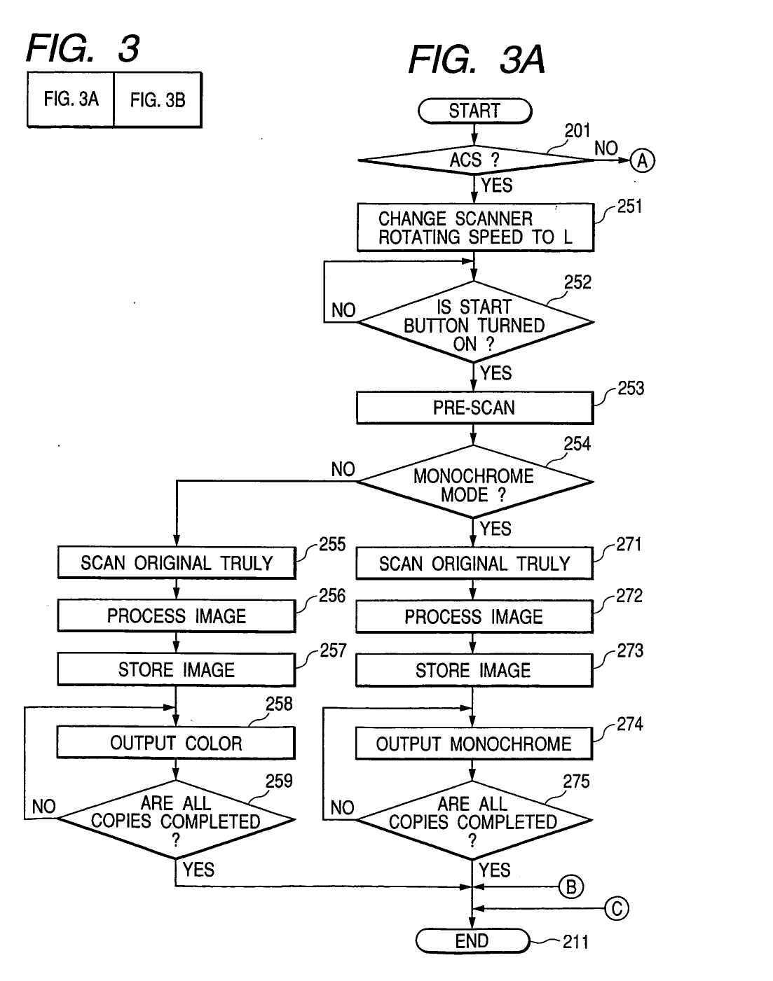

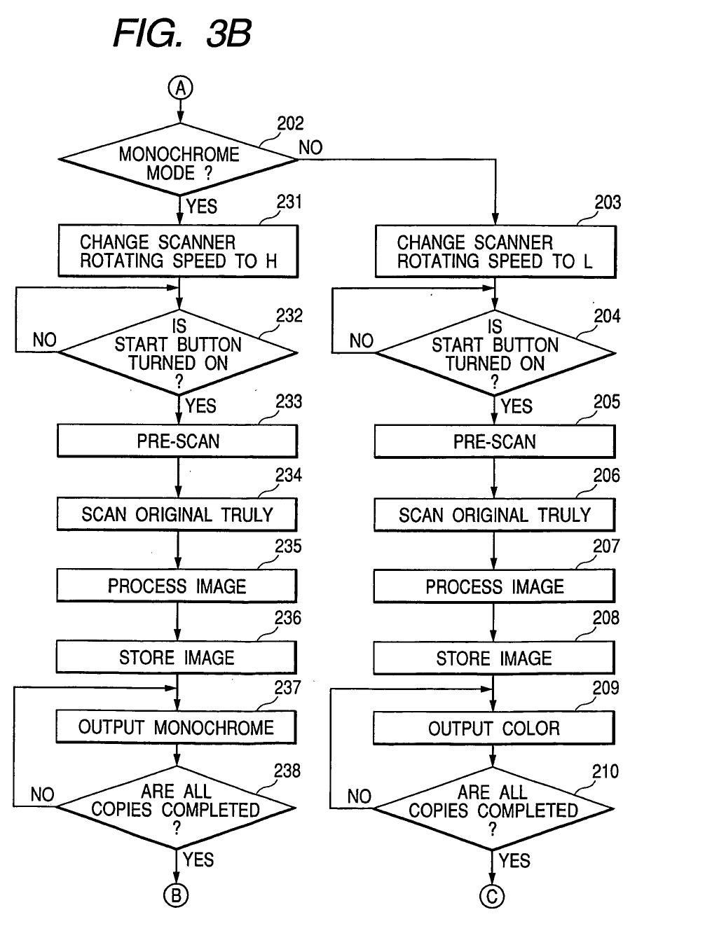

FIG. 3 is a flowchart showing the outline of an image forming process of the image forming apparatus according to the embodiment shown in FIG. 1.

Firstly, prior to start of the operation, it is discriminated what mode is set. Specifically, it is discriminated whether or not the set mode is ACS (Auto Color Select) mode in which image discriminating means (control portion 104) discriminates whether the original is a monochrome (i.e. black and white) original or a color original (in step 201). In connection with this, selecting or not selecting the ACS mode is set through an operation of the operating portion (serving as image discriminating operation selecting means) 112. If it is discriminated that the ACS mode is not set, it is discriminated then whether or not monochrome mode is set (in step 202). Setting of the monochrome mode is also performed through an operation of the operating portion (serving as mode selecting means). If the set mode is not the monochrome mode, it is discriminated that the set mode is color mode, and the rotating speed of a scanner motor is set to keep a normal rotating speed that is suitable for color image forming (color mode) (in step 203).

Next, when a start button provided in the operating portion 112 is pressed (in step 204), a pre-scan of the original is performed first in the reader portion 101 (in step 205), so that the size of the original etc. is discriminated. Based on the results of the pre-scan, an actual scan (or main scan) of the original is performed by the reader portion 101 (in step 206), and the signal output from the CCD sensor 34 is subjected to image processing such as shading compensation, gray level correction and color correction etc. in the image processing unit 102 and then stored in the memory 103 as an output signal (in steps 207 and 208).

Based on the signal stored in the memory 103, the printer portion performs exposure, development and transfer operations repeatedly for respective colors M, C, Y and Bk in the mentioned order, and then the image is fixed and output by the fixing device 9 (step 209).

After the above-described process has been repeated for a designated number of sheets (or copies) have been output, the operation is ended (in step 210 and 211).

Next, a description will be made of a flowchart in the case in which the monochrome mode is set.

When it is discriminated (in step 202) that the monochrome mode is set, the rotating speed of the scanner motor is set to a high rotating speed corresponding to high speed monochrome image forming (monochrome speed-priority mode) (in step 231).

When the start button provided in the operating portion 112 is pressed (in step 232), a pre-scan of the original is performed first in the reader portion 101 (in step 233), so that the size of the original etc. is discriminated. Based on the results of the pre-scan, an actual scan of the original is performed by the reader portion 101 (in step 234). At that time, the scanning of the original is performed at a scanning speed corresponding to a high process speed.

Then, the signal output from the CCD sensor 34 is subjected to image processing such as shading compensation and gray level correction etc. in the image processing unit 102, and then stored in the memory 103 as an output signal (in steps 235 and 236).

Based on the signal stored in the memory 103, the printer portion performs exposure, development and transfer operations with settings suitable for the monochrome speed-priority mode as described above and then the image is fixed and output by the fixing device 9 (step 237).

After the above-described process has been repeated for a designated number of sheets (or copies) have been output, the operation is ended (in step 238 and 211).

In this monochrome speed-priority mode, the rotating speed of the scanner motor is changed at the time when the mode is selected, in other words, prior to the commencement of the actual copying operation. Therefore, the waiting time until stabilization of the rotating speed in connection with the change in the rotating speed can be shortened.

Next, a description will be made of a flowchart in the case in which the ACS mode is set.

When it is discriminated (in step 201) that the set mode is the ACS mode in which whether the original is a monochrome original or a color original is automatically discriminated, the rotating speed of the scanner motor is set to keep a low rotating speed that is suitable for color image forming (in step 251).

When the start button provided in the operating portion 112 is pressed (in step 252), a pre-scan of the original is performed first in the reader portion 101 (in step 253), so that the type of the original (i.e. monochrome original/color original) and the size of the original etc. are discriminated (in step 254).

If it is discriminated that the original is a color original (color mode), an actual scan of the original is performed by the reader portion 101 based on that result of the discrimination (in step 255). Then, the signal output from the CCD sensor 34 is subjected to image processing such as shading compensation, gray level correction and color correction etc. in the image processing unit 102, and then stored in the memory 103 as an output signal (in steps 256 and 257).

Based on the signal stored in the memory 103, the printer portion performs exposure, development and transfer operations repeatedly for respective colors M, C, Y and Bk in the mentioned order, and then the image is fixed and output by the fixing device 9 (step 258).

After the above-described process has been repeated for a designated number of sheets (or copies) have been output, the operation is ended (in step 259 and 211). The above-described image forming process is the same as the process in the color mode described before.

On the other hand, if it is discriminated that the original is a monochrome original (normal monochrome mode), an actual scan of the original is performed by the reader portion 101 based on that result of the discrimination (in step 271). Then, the signal output from the CCD sensor 34 is subjected to image processing such as shading compensation and gray level correction in the image processing unit 102, and then stored in the memory 103 as an output signal (in steps 272 and 273).

Based on the signal stored in the memory 103, the printer portion performs exposure, development and transfer operations, and then the image is fixed and output by the fixing device 9 (step 274).

After the above-described process has been repeated for a designated number of sheets and a designated number of copies have been output, the operation is ended (in step 275 and 211). The above-described process is performed at a process speed the same as that in the color mode, though the process is in the monochrome mode.

In the case in which mixed originals including monochrome originals and color originals are continuously copied with use of an original changing apparatus while it is automatically discriminated in the ACS mode whether each original is a monochrome original or a color original, the process speed is not changed even if the mode switching is effected between the monochrome mode and the color mode. Therefore, there is no wait time required for stabilization of the driving motor upon each mode switching, and so productivity is not reduced significantly.

In this embodiment, the description has been made with reference to an apparatus that is provided with an original reading apparatus with which the type of an original is discriminated and mode setting is effected. However, it will be apparent that the present invention can also be effectively applied to printers that are connected to a computer(s) or a network, etc. In the case in which image forming is performed based on image information sent from a computer etc., the ACS (Auto Color Select) function may be realized by discriminating whether the sent image information is monochrome image information or color image information.

Furthermore, in the above-described embodiment, the description has been made to the feature in which the process speed for black-and-white image forming is increased. However, it will be apparent that the process speed may also be increased in single color image formation other than black image formation.

While the invention has been described with reference to the structure disclosed herein, it is not confined to the details set forth and the invention is intended to cover such modifications or changes as may come within the purposes of the improvements or the scope of the following claims.

1. An image forming apparatus in which an image forming speed can be changed in accordance with an image forming mode, comprising:
a plurality of image forming means for forming images of different colors based on image information;
transferring means for transferring the images formed by said plurality of image forming means sequentially in a superimposing manner;
image discriminating means for automatically discriminating whether said image information is monochrome or multi-color;
image discriminating operation selecting means for selecting whether or not said image discriminating means is to be operated; and
mode selecting means for selecting between a monochrome image forming mode and a multi-color image forming mode when said image discriminating operation selecting means is not selected,
wherein, when said image discriminating means is selected to be operated by said image discriminating operation selecting means, an image forming speed at a time of monochrome image forming and at a time of multi-color image forming is set to a first speed, irrespective of a result of discrimination by said image discriminating means,
and wherein, when said monochrome image forming mode is selected by said mode selecting means, an image forming speed at the time of monochrome image forming is set to a second speed that is higher than said first speed.

2. An image forming apparatus according to claim 1, wherein
said image forming means comprises an image bearing member and scanning exposure means for performing scanning exposure in order to form a latent image on the image bearing member, and
said scanning exposure means comprises a light source, a reflecting member that reflects light emitted from said light source while rotating, and driving means for rotating said reflecting member, and
wherein when the image forming speed is changed, a driving speed of said driving means is changed.

3. An image forming apparatus according to claim 2, wherein when said monochrome image forming mode is selected by said mode selecting means, the driving speed of said driving means is changed prior to start of an image forming operation.

4. An image forming apparatus according to claim 1, wherein when said multi-color image forming mode is selected by said mode selecting means, the image forming speed at the time of multi-color image forming is set to said first speed.

5. An image forming apparatus according to claim 1, wherein said monochrome is black.

6. An image forming apparatus according to claim 1, said image discriminating means uses image information obtained by reading means that reads an original image.
